(19) United States
(12) Patent Application Publication
(10) Pub. No.: US 2005/0055289 A1
(43) Pub. Date: Mar. 10, 2005

(54) Multi-dimensional business information accounting software engine

(76) Inventor: Robert Allen Mehldahl, Basking Ridge, NJ (US)

Correspondence Address: Ernest D. Buff;Ernest D. Buff & Associates, LLC, 231 Somerville Road, Bedminster, NJ, 07921, US

(21) Appl. No.: 10/970,874

(22) Filed: Oct. 22, 2004

Related U.S. Application Data
(63) Continuation-in-part of application No. 09/924,704, filed on Aug. 9, 2001.

(51) Int. Cl. G06F 17/60

(52) U.S. Cl. 705/30

(57) ABSTRACT

A multi-dimensional business information accounting software engine accepts input of user defined business specific textual or numeric information and conventional financial accounting data and converts them to indexed star schema multi-dimensional computer data as a journal entry. Upon user request the journal entry is analyzed by relational or other database methodology to generate conventional accounting statements such as general ledger, balance sheet, cash flow statements, profit and loss statements and earned income statements for user specified time periods. The multi-dimensional business information accounting software engine can also generate accounting statements of sliced data according to a range of business specific numeric information or accounting statements pertinent to a textual business specific information for a specified time period, providing the user sensitivity of different business specific information on accounting statements, so that the user can modify his business practices on real time.

This is a Continuation-In-Part of application Ser. No. 09/924704, filed Aug. 9, 2001, the disclosure of which is hereby incorporated in its entirety by reference thereto.

### BACKGROUND OF THE INVENTION

1. Field of the Invention

The present invention relates to computer based accounting systems; and more particularly to a multi-dimensional database software engine that integrates business specific information with accounting data.

2. Description of the Prior Art

Many patents address issues related to computer based accounting systems, which provide conventional accounting information based on journal entries in the form of general ledger, income statement, statement of retained earnings, statement of cash flow and balance sheet. Business decisions require accounting information, which is specific to business related issues. Conventional monthly or three month accounting information systems do not provide a clear picture of business activities. Consequently, business executives have to rely on intuition or other collected data to make timely business decisions.

U.S. Pat. No. 5,189,608 to Lyons et al. (hereinafter, the “608 patent”) discloses a method and apparatus for storing and generating financial information employing user specified input and output formats. The method disclosed by the '608 patent is an advanced financial reporting and analysis software package that collects, organizes, manages and consolidates financial data and provides user defined capabilities for creating financial and corporate reports. Financial data is organized into four business classifications or dimensions—Schedule, Entity, Period and Type. Schedule identifies the kind of document the data comes from (e.g., an income statement, a tax schedule). Entity identifies the reporting group within the business organization (e.g., departments, divisions, subsidiaries). Period identifies the range of time that the data represents (e.g., FY 87, Q2 87). Type provides an additional dimension that can be used to further categorize the data (e.g., actual, budget, forecast). Data is stored in the system in such a way that all data associated with a particular Schedule, Entity, Period and Type is identified by a particular SEPT value. A template is provided for data entry from spreadsheet packages or user entry, and data associated with particular SEPT values is converted to desired output formats. The system disclosed by the '608 patent does not collect any data in addition to the SEPT values. In addition, the system does not provide general ledger, cash flow and other standard accounting functionality. Further the '608 patent system does not provide financial information that is combined with business information.

U.S. Pat. No. 5,740,427 to Stoller discloses a modular automated account maintenance system. The disclosed accounting system is directed towards small business processes predefined business transactions, defined by a core part and an auxiliary part. The core part defines a specific accounting process and the auxiliary part contains data specific to the transaction, such as customers, vendors, lessors, invoices, purchase orders, and cash sales. The two parts are assigned the same unique identifier number and then stored in two different storage mediums. Any transaction can be retrieved and reassembled using the unique identifier number. The core part defines which accounts are affected by the transaction and generates updates to those accounts. The core and auxiliary transaction information may include items such as monetary amounts, dates, references to business and accounting entities, tax rates, and the like. No means are disclosed to combine business information and accounting information to provide data for business analysis.

U.S. Pat. No. 5,875,435 to Brown discloses an automated accounting system. This accounting system allows transactions to be input at various remote locations and allows access to the system by an agent of the business. An agent of the business can include a party such as an accountant, who is at a remote location to perform certain operations, such as entering, deleting, reviewing, adjusting and processing. The system provides a menu of financial transactions and itemization codes to facilitate the input of data. The system is used to prepare and print income, expense, assets and liability statements. The disclosed system has no business specific information recorded with the transaction data and does not provide business specific information.

U.S. Pat. No. 5,974,396 to Anderson et al. discloses a method and system for gathering and analyzing consumer purchasing information based on product and consumer clustering relationships. The retailer or a retail chain is provided with the ability to process transactional information involving large numbers of consumers and consumer products. This is accomplished by gathering product information that uniquely identifies a specific product by type and manufacturer, grouping that product information into product clusters, and analyzing consumer retail transactions in terms of those product clusters to determine relationships between the consumers and the products. The system thus tracks the buying habits of consumers and creates direct advertisements that are sent to individual consumers based on the consumers' past purchases. A database is used to store information on the consumers and each consumer is associated with at least one product cluster. Specific consumers are then targeted according to the cluster information. A user interface at the retail store, or at the supervisory retail processor, allows a retailer to input specific queries to the system to retrieve particular types of information from the relational database. Including determining such information as purchasing behaviors of retail consumers, the effectiveness of promotional efforts with respect to particular products, and particular characteristics (demographics and otherwise) of consumers that purchase particular products. Although the disclosed method and system provides the user with an analysis of consumer information, it does not perform any accounting functions.

U.S. Pat. No. 6,026,397 to Sheppard discloses a data analysis system and method. This data analysis system and method assigns customers to socio-demographic groups according to similar characteristics parameters. The demographic groups are analyzed to predict future customer behavior based upon past customer behavior, product preference, and propensity to respond to direct mailings. The disclosed system and method does not provide any accounting functionality. Furthermore, the disclosed system and method does not provide financial information combined with business information.

U.S. Pat. No. 6,275,813 to Berka discloses a method and device for posting financial transactions in a computerized accounting system. The transcription software records actual transactions as transfers of money between two of five accounting categories including income (I), expenses (E), assets (A), liabilities (L) and capital (C). The directional graphic character “<” visually indicates the direction of transfer between a user-input source and a destination category, always pointing at the destination category, thus assisting the user in posting the actual transactions with the destination as debit category and source as credit category. The general ledger may be user created or automatically posted by the computer. A plurality of account titles are assigned to each of the four basic categories (I, E, A, L), and each title includes a numeric identifier and a descriptive name. The first digit in the identifier denotes a category and the remaining digits denote an account number and the transaction is stored as a decimal record in a journal entry comprising the amount and the numeric identifier. The disclosed method and device is an accounting program that merely aids the user, or at best creates a general ledger. No business information is collected or combined with financial information.

U.S. Pat. No. 6,330,545 to Suh discloses activity information accounting method and system. The activity information accounting system stores an account title table corresponding to activity information, and performs accounting procedures on the basis of input activity information and an account title corresponding to the input activity information. The accounting system displays activity types including purchase and acquisition activity, sales and revenue activity, expenditure activity, investment and finance activity, and production activity. If a user selects one of the displayed activity types, the accounting system displays a screen for the user to input activity information for the selected activity type. The accounting system determines if the input activity information is internal activity or external activity, performs accounting procedures on the basis of determined result and the account title table. The accounting method and system enables those not trained in the field of accounting to be able to prepare accounting reports by simply inputting business activity information. The accounting reports prepared include balance sheets, income statements, cash flow statements and other accounting reports that provide different measures of overall company worth and performance, without having to undergo the complicated process of making journal entries. The disclosed accounting method and system does not provide financial information combined with business information since it collects only user inputted activity information.

U.S. Pat. No. 6,397,195 to Pinard et al. discloses a system for managing accounting information in a multi-dimensional database. A method and apparatus are provided for managing accounting information of entities having different fiscal calendars. A memory stores accounting data for at least two entities, each of the entities maintaining the accounting data according to a different fiscal calendar. A user interface enables a user to request consolidated accounting information for the entities. Accounting data and/or calendar information of the entities is mapped to a base calendar maintained in the computer system. A processor is provided for accessing the accounting data according to the base calendar instead of the entity calendars to recover, for a specified time period, accounting information responsive to a user request entered via the user interface. The processor consolidates the accounting information for the different entities according to the base calendar. The computer system will provide the consolidated accounting information to the user without further user intervention, and without the user even having to know that the disparate calendars have been accounted for by reliance on a base calendar maintained by the computer system. This system operates with users that have different fiscal calendars and reconciles their accounts according to a common base calendar resident in the computer. Significantly, the disclosed system does not provide any accounting functionality, such as general ledger etc., and does not integrate financial information with business information.

U.S. Pat. No. 6,442,533 to Hinkle discloses a multi-processing financial processing system. The financial transaction processing system provides substantial processing efficiencies resulting in a substantial decrease in the size of an executable code. Each transaction is described by a transaction data descriptor that includes a series of sub-transaction data descriptions concerning actions that can be performed independently of one another. Thus, complex transaction processing logic is substantially removed from the executable code, and instead such transaction data descriptors are processed interpretatively and processed in parallel. Accordingly, the multi-processing financial processing system may be viewed as a software engine, or a user-definable transaction-processing tool that can be adapted to a variety of industry specific software application needs without changing the actual program code. That is, by surrounding the multi-processing financial processing system with application specific software for inputting transaction data to the multi-processing financial transaction processor and retrieving data from the multi-processing financial transaction processor, a particular business enterprise can have substantially all of its financial records in condition for auditing on a daily or weekly basis. The patent reveals a multi-processing financial transaction processor with user defined financial processing capability. No provision for integrating business specific information with accounting information is provided. Furthermore, all financial transaction-processing rules have to be user defined which in turn requires considerable programming.

There remains a need in the art for a reliable, multidimensional accounting software that integrates financial accounting information with business information, thereby providing improved guidance to executives formulating business decisions.

### SUMMARY OF THE INVENTION

In accordance with the present invention a complete business specific information and accounting system can be managed by a single software engine that accepts business transactions data as multi-dimensioned data and, at the user's request, produces and generates standard accounting reports. Including such reports as Balance Sheets, Income Statements, Retained Earnings Statements, Cash Flow Statements, and accounting reports that are particular to business specific information. These standard accounting reports are produced from an underlying data structure that categorizes data in any number of dimensions. Each dimension represents a different way of categorizing the transaction. Implicit in this model are the four dimensions necessary for the accounting process, the debit dimension, the credit dimension, the calendar date dimension, and the description dimension and other dimensions representing business specific information.

The multi-dimensioned data may comprise other dimensions that are added by the user according to specific business information needed in addition to dimensions representing the four dimensions necessary for the accounting process detailed above. When the multi-dimensional business information account software engine is set up at a business location, the business owner decides what business data needs to be collected in addition to the accounting variables. In the case of a retail business, these business factors may include customer name, customer address, store location, customer gender and the like. In the case of an apartment rental business, business data may include apartment number, apartment building, renter's name, nature of expense (repair, modification etc.). The business factors are determined by the business owner based on what the business owner considers to be important factors. The software allows additions of new business data to be collected and tracked by the multi-dimensional business information and accounting software engine without compromising the integrity of data already collected, providing the business owner the capability to change his tracking capability of business factors.

The accounting system accepts data as a single piece of inputted information and creates all standard accounting reports and business specific accounting information for any selected time period, which may be entirely arbitrary or fixed time periods such as weekly, bi-weekly, monthly or quarterly. Unlike conventional accounting process, the multi-dimensional business information accounting software engine has no general ledger and no ledger accounts that exist as a repository of transaction information. Because there are no ledger and ledger accounts, there are no closing operations that are required to determine the balances of some of the ledger accounts (the so-called “temporary accounts” used to determine revenue, expenses, and dividends). The software generates these reports from the inputted data extremely fast for the time period selected, displaying the data in a conventional accounting sheet format that the user expects to see. In addition to these standard features, the multi-dimensional business information account software engine can slice the data with respect to specific business factors for the time period selected, to accurately display the influence of the selected business factors on financial outcomes. This powerful capability allows the business owner to determine if the influence of a given business factor has changed over a period of time. He may also determine if some other business factor has a larger influence on financial outcomes of the business so that he may have to modify business operations by paying more attention to those high influence business factors.

The key features of the multi-dimensional business information accounting software engine include, in combination, the features set forth below:
1. A user interface to define key business factors to be collected by a multi-dimensional business information accounting software engine in addition to the four dimensions necessary for the accounting process, the debit dimension, the credit dimension, the calendar date dimension, and the description dimension;
2. The user inputting business data and accounting information manually during a transaction;
3. The user inputting business data and accounting information using a bulk loader which accumulates a large number of transaction data;
4. The user interrogating the multi-dimensional business information accounting software engine to provide financial sheets including balance sheets, general ledger, cash flow statements, and profit and loss statements for any selected time periods;
5. The user interrogating the multi-dimensional business information accounting software engine to provide data slice of financial sheets including balance sheets, general ledger, cash flow statements, and profit and loss statements for any selected time periods based on selected business criteria;
6. The data obtained in steps 4 and 5 used to make timely business decisions on business practice;
7. The multi-dimensional business information accounting software engine having the capability for adding additional business variable definitions without compromising the integrity of data already collected, thereby providing the business owner with the capability to monitor the business function in a dynamic manner.

### BRIEF DESCRIPTION OF THE DRAWING

The invention will be more fully understood and further advantages will become apparent when reference is had to the following detailed description of the preferred embodiments of the invention and the accompanying drawings, in which:

FIG. 1 is a diagrammatic representation of the star schema or entity relationship diagram of the data structure of the multi-dimensional business information accounting software engine;

FIG. 2 is a diagrammatic representation of the system architecture of the multi-dimensional business information accounting software engine;

FIG. 3 is a diagrammatic representation of the sequence of operations in inputting data into the multi-dimensional business information accounting software engine;

FIG. 4 is a diagrammatic representation of the sequence of operations in requesting output data from the multi-dimensional business information accounting software engine and operations performed by the software engine;

FIG. 5 is a flow chart that represents the prior art, detailing how the traditional accounting process is performed;

FIG. 6 is a flow chart that represents the accounting process performed by the multi-dimensional business information accounting software engine;

FIG. 7 is a diagram of a traditional accounting journal according to the prior art;

FIG. 8 is a journal using the multi-dimensional business information accounting software engine;

FIG. 9 is a journal with additional references, besides those that are specific, to performing the traditional accounting functions using the multi-dimensional business information accounting software engine;

FIG. 10 is the data structure that contains the ledger accounts instantly created and displayed by the software engine that appears similar to a conventional ledger;

FIG. 11 demonstrates how dimensional references go from the rows of the journal to a data structure holding the ledger accounts;

FIG. 12 is the data structure that contains a non-accounting dimension;

FIG. 13 is an Entity Relationship (ER) diagram showing the star schema for a simple accounting application implementing the traditional accounting functions;

FIG. 14 is an Entity Relationship diagram showing the star schema for an extended accounting application implementing business dimensions with traditional accounting functions;

FIG. 15 is a two-dimensional data structure where each dimension is a ledger account with an inadequate data structure for accounting;

FIG. 16 is an Entity Relationship diagram showing the star schema for a simple two-dimensional accounting system for ledger accounts only;

FIG. 17 is an Entity Relationship diagram showing the star schema for a simple three-dimensional accounting system for ledger accounts and the date;

FIG. 18 is a three-dimensional “cube” containing the three dimensions, debit account, credit account, and date account, shown in the Entity Relationship diagram;

FIG. 19 is the three-dimensional cube previously shown in FIG. 18 with a “slice” made through one of its dimensions;

FIG. 20 is the three-dimensional cube originally shown in FIG. 18 with a “slice” made through its credit dimension;

FIG. 21 is the three-dimensional cube originally shown in FIG. 18 with a slice through two dimensions, a debit dimension for the Cash account and a credit dimension for the Rent account; and

FIG. 22 is the three-dimensional cube originally shown in FIG. 18 with a slice through three dimensions: a debit dimension for the Cash account; a credit dimension for the Rent account; and a data dimension for the date Apr. 2, 2004.

Although a multi-dimensional data structure is conveniently implemented using a star schema design technique or entity relationship diagram in a relational database, that particular embodiment does not limit it as an invention. Any structuring of data that supports a star schema suffices as a raw material upon which this invention can be based. Rather than a relational database designed with interrelated tables, the exact implementation could be a set of text files on a hard-disk drive that contain references to each other. The exact implementation in a relational database (or any other form of interrelating the data) is a matter of expression and is the subject of copyright law as opposed to patent law where it is the idea, as opposed to its specific expression, that is relevant.

### DETAILED DESCRIPTION OF THE INVENTION

Various accounting software applications have been developed and marketed. However, all of these applications have followed the conventional model that has dominated the accounting profession for over five-hundred years. According to that model, each business transaction is recorded in three different places. The transaction is entered once in a journal (an historical record of all transactions) and then it is entered in two accounts in the general ledger. In one of the general ledger accounts it is recorded as a debit and in the second general ledger account it is recorded as a credit. The accounts in the general ledger are then treated as the primary source of transaction information in accounting, with the journal being used primarily as a backup to the general ledger accounts. There are no records associated with business factors.

The multi-dimensional business information accounting software engine takes a revolutionary new approach to accounting. It treats the journal itself, which combines account information and business factor information, as the sole source of information for generating accounting reports and does not even enter the information in general ledger accounts. It treats the general ledger as a useless vestige of the “paper and pencil” days and recognizes that it serves no useful purpose in electronic data processing. Unlike the conventional accounting practice wherein the general ledger accounts serve the purpose of categorizing the business transaction, the multi-dimensional business information accounting software engine performs this categorization through the dimensions in the underlying multi-dimensional data structure. A dimension in a computer data structure is an index that is used to access a piece of data. For example, in a single dimension data structure an index of 4 accesses the fourth element in the row that makes up the single dimension. In a two dimensional data structure, the row index of 6 and the column index of 8 will access the eighth element of the sixth row in the two dimensions that make up the data structure. Any number of dimensions can be given to the data. In the multi-dimensional business information accounting software engine, the journal entry is used to perform calculations to generate the ledger accounts according to the dimensions of the journal data structure. Each transaction has a debit dimension, a credit dimension, a calendar date dimension, and a description dimension, as well as any number of other dimensions or business factors that the user has selected to categorize the transaction. This revolutionary multi-dimensional approach to accounting makes the multi-dimensional business information accounting software engine a unique invention that has no precedent in the business world. Providing the business owner timely standard accounting sheets including general ledger, cash flow statements, and profit and loss statements for any specified time period. The software engine also provides the relationship between financial information and selected business factors.

It is important to recognize what is meant by the term “multi-dimensional data structure.” This term includes, but is not synonymous with, the implementation of a star schema in a relational database. It is not intended to be exclusively the use of a relational database in a manner typical of data warehouse and On-Line Analysis Processing (OLAP) implementations. As used herein, the term “multi-dimensional data structure” is intended to mean the interrelating of the financial amount of a business transaction to the factors of the business that the transaction affects by way of dimensional references.

Dimensional references, in turn, are indices into a particular category that a business transaction can belong to. For example, the accounting concept of “debit” is a category of accounts that represent various factors of the business. The debit category of accounts is a dimension of the business and the particular account that is debited is indicated by a reference that is attached to the transaction's representation as stored data. The “debit” dimensional reference attached to the transaction's data indicates which account in the category of company accounts is affected in a debit manner by the transaction.

The dimensional reference is typically a simple small integer that is used as an index to another record in a second table or file. This second record may have other attributes (i.e. the name of the account, where the account fits into the accounting equation, etc.), but this record is identified by the small integer that matches the reference found in the original record of the affecting transaction.

Generally stated, the present invention provides a multi-dimensional business information accounting software engine that accepts business information, including business factors and accounting factors, manually inputted or loaded from a bulk loader. The only place where data needs to be stored is in the multi-dimensional data structure, which serves as a journal. The balance sheets, cash flow statements, income statements and retained earnings statements are all generated directly from this data structure using the powerful speed of the computer to obviate the needs for a general ledger.

The business owner sets up the multi-dimensional business accounting software engine by selecting business factors to be captured in addition to four standard accounting factors. The conventional accounting statements within the multi-dimensional business information accounting software engine are virtual and are based on the accounting factors captured in the data. These accounting statements are created instantly when they are requested for a specified time period while the journal entry, which is a sequential accumulation of inputted data, is the only stored information within the multi-dimensional business information accounting software engine. The accounting software engine is flexible so that the business owner can add additional business factors to be captured at any time without destroying the integrity of already collected data.

Thus the multi-dimensional business information accounting software engine can be configured to maintain any number of additional dimensions besides the standard accounting dimensions of the debit account, the credit account, and the time. Each additional dimension offers the business a different way to categorize the business transactions for the purpose of market analysis, expense tracking, and other interesting ways of forming information. A multi-dimensional data structure, used to implement what is called a star schema, is a powerful structure for “slicing” data. The term “slicing” is intended to mean summing up the transactional amounts according to one or more of the dimensions in the multi-dimensional data structure. With a few dimensions, there can be thousands of different possible slices that can be made, each slice providing a new insight into the data. The multi-dimensional business information accounting software engine thus blurs the lines that separate accounting from the newer practices of On-Line Analysis Processing (OLAP) and data mining.

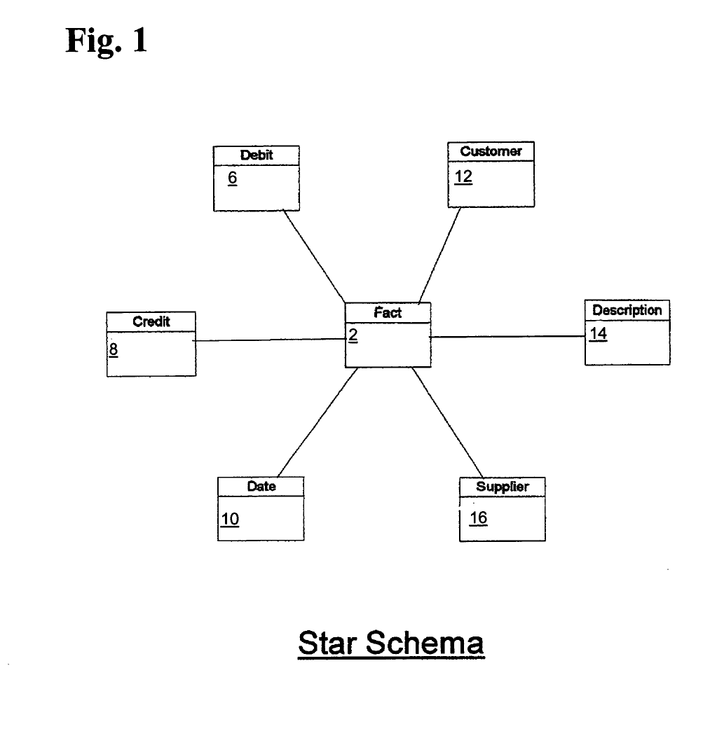

Referring to FIG. 1, there is shown a diagrammatic representation of the star schema of data structure of the multi-dimensional business information accounting software engine that lies at the heart of the invention. When this data structure is implemented in a relational database each box in the figure would be a table, although the multi-dimensional data structure can be implemented in another form other than in a relational database. The primary characteristic of the data structure's design is best represented by a “star” shape, generally referred to as a “star schema”. There is typically a single table in the center at 2, referred to as a “fact” table that is surrounded by a number of dimensional tables. These dimension tables are represented by the boxes numbered 6, 8, 10, 12, 14, and 16. Each record in the fact table contains one or more amount field, e.g. the amount of the business transaction, and a reference or index to a record in each of the dimension tables. A record in the fact table may have an amount of one-hundred dollars and an index to the record in the credit dimension that represents the “Cash” account and an index to a record in the debit dimension that represents an “Office Furniture” account. Further indexes in the fact record would reference records in the remaining dimension tables. Groups of the dimensions can be used in combination with each other to categorize the transactions in the fact table. In this star schema, dimension 10 representing date, dimension 8 representing credit, dimension 6 representing debit and dimension 14 representing description relate to traditional accounting factors while dimension 12 representing customer and 16 representing supplier are specific business factors to be recorded and chosen by the business owner. The business factors may be different and may be more dimensions as chosen by the owner.

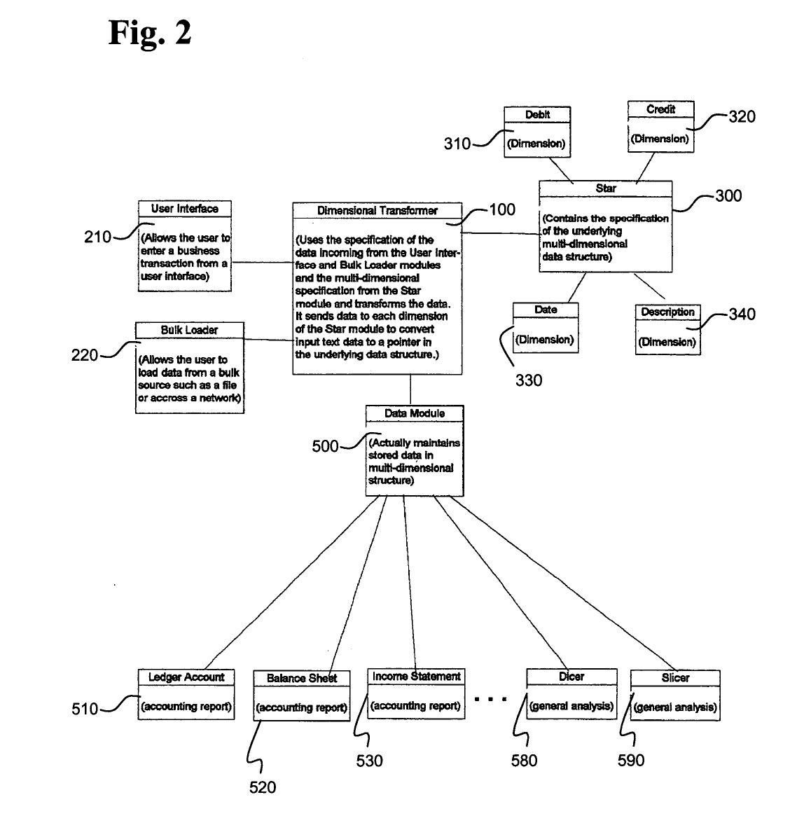

Referring to FIG. 2, there is shown generally a diagrammatic representation of the system architecture of the multi-dimensional business information accounting software engine. Each box in this figure is a software component representing one or more objects, in the invention's object-oriented architecture. Each component is named and numbered and given a short description. Central to the figure is the component named the Dimensional Transformer, numbered 100. This component converts conventional, non-dimensional data, typical of accounting journal entries, into data that has dimensions and is ready to be loaded into the underlying multi-dimensional data structure. The data that is input into this component has a monetary amount, as do all accounting transactions, as well as the name of the account that is debited by the transaction, the name of the account that is credited by the transaction, the date of the transaction and business factor dimensions. The Dimensional Transformer component (100) is responsible for converting the name of the debit account to an index number in the debit dimension of the multi-dimensional data structure. It also is responsible for making this same conversion of the name of the credit account to an index in the credit dimension. Any additional dimensions, such as business factors, are also handled the same way by the Dimensional Transformer (100) component. The user is free to define the specific business factors for the input data and is also free to define the dimensions of the underlying data structure. The Dimensional Transformer (100) is configured with both definitions and how they are mapped to each other before the journal entries are entered. The definitions of the input data are given to the Dimensional Transformer (100) by one of the two input components, either the User Interface component (210) or the Bulk Loader component (220). The definition of the underlying multi-dimensional data structure is read in from an external file. The User Interface component (210) is used by a user that enters transactions through a Graphical User Interface (GUI) or window environment. The Bulk Loader component (220) first passes a definition of its input data to the Dimensional Transformer (100). It then begins to pass large numbers of journal entries, in bulk, to the Dimensional Transformer (100). The Star component (300) contains a structure that is isomorphic with the underlying data structure. For each dimension in the underlying data structure there is a dimensional component that is managed by the Star component. Examples of these dimensional components are the Debit component (310), the Credit component (320), the Calendar Date component (330), and the Description component (340) and other business factor components (not shown). Each of these dimensional components knows how to convert input data into an index into the corresponding dimension in the underlying data structure. The Dimensional Transformer component (100) uses these dimensional components to actually perform the transformation of the individual dimension. The Data Module component (500) is the software entity that manages the underlying multi-dimensional data structure. It is a “plug-and-play” interchangeable component that can be replaced by other versions that allow the underlying data structure to be implemented as a relational database or other alternative. The components numbered 510, 520, and 530 are logically simple components that use the multi-dimensional aspects of the Data Module component (500) to produce conventional accounting reports or accounting reports specific to business factors. There are additional modules of this sort that satisfy all the practices recommended by the Generally Accepted Accounting Principles (GAAP). The Dicer component (580) is a module that allows the non-technical user to dynamically piece together dimensions in order to make an ad hoc analytical study. The Slicer component (590) allows a user to choose between a number of pre-written analytical studies that have been developed by the user at an earlier time and that are stored with the multi-dimensional business information accounting software engine.

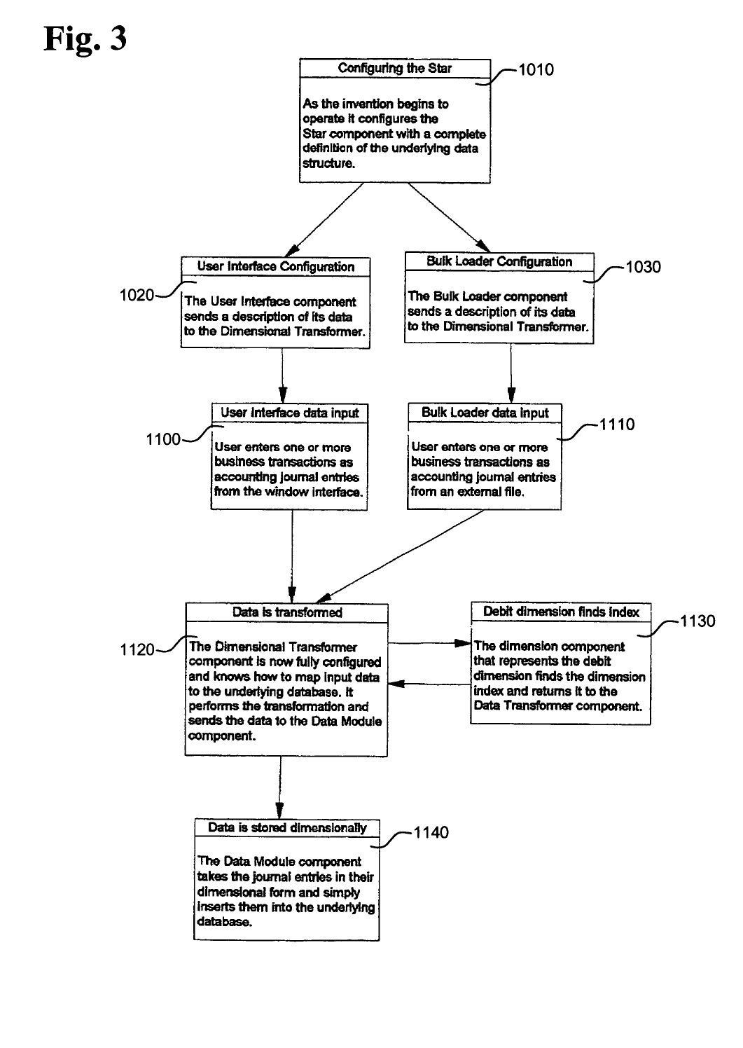

Referring to FIG. 3, there is shown generally a diagrammatic representation of the sequence of operations in inputting data to the multi-dimensional business information accounting software engine. Starting from the top of the figure and proceeding downward, the multi-dimensional business information accounting software engine starts-up and reads-in a complete definition of the structure of the underlying database (1010), which has the standard accounting dimensions and business factor dimensions se up previously by the user. The Star component (2 of FIG. 1, 300 in FIG. 2) is constructed with all of the definitions that exist in the database. After this operation, the multi-dimensional business information accounting software engine is prepared to work with any module that attempts to enter business transactions. The data entry modules (1020) and (1030) begin the process of inserting transactions. The User Interface component (210 in FIG. 2) and the Bulk Loader component (220 in FIG. 2) begin by sending the structures of their input data and a mapping of how this data relates to the underlying database structure. Both input components have knowledge of the Star component and contain mappings from their input to the dimensions of the Star component. At this point in time the Dimension Transformer (100 in FIG. 2) has all of the information necessary to convert the input to a multi-dimensional form. With all of the data definitions given to the Dimensional Transformer component the input modules (210 and 220 in FIG. 2) begin to send their transactions to the Dimensional Transformer component. This is shown in steps 1100 and 1110 of the figure. In step 1120, the Dimensional Transformer component converts the data from plain text to a fact record containing a set of dimensional indexes. In step 1130 the Dimensional Transformer component is taking the name of the debit account as text and sending it to the Debit Dimension component (310 in FIG. 2). This Debit Dimension component contains a mapping from the set of allowed text entries (the names of all the accounts) to the indexes that represent them in the debit dimension of the underlying database. The Debit Dimension component finds the proper index and returns it to the Dimensional Transformer component then adds the index to the multi-dimensional fact record that it is building. The Dimensional Transformer component does this for each dimension in the database. When all the dimensions are resolved the Dimensional Transformer component sends the new multi-dimensional fact record to the Data Module component (FIG. 500 in FIG. 2) where the fact record is added to the underlying data structure as shown at (1140). At this point, the journaling of new transactions in the multi-dimensional database is complete.

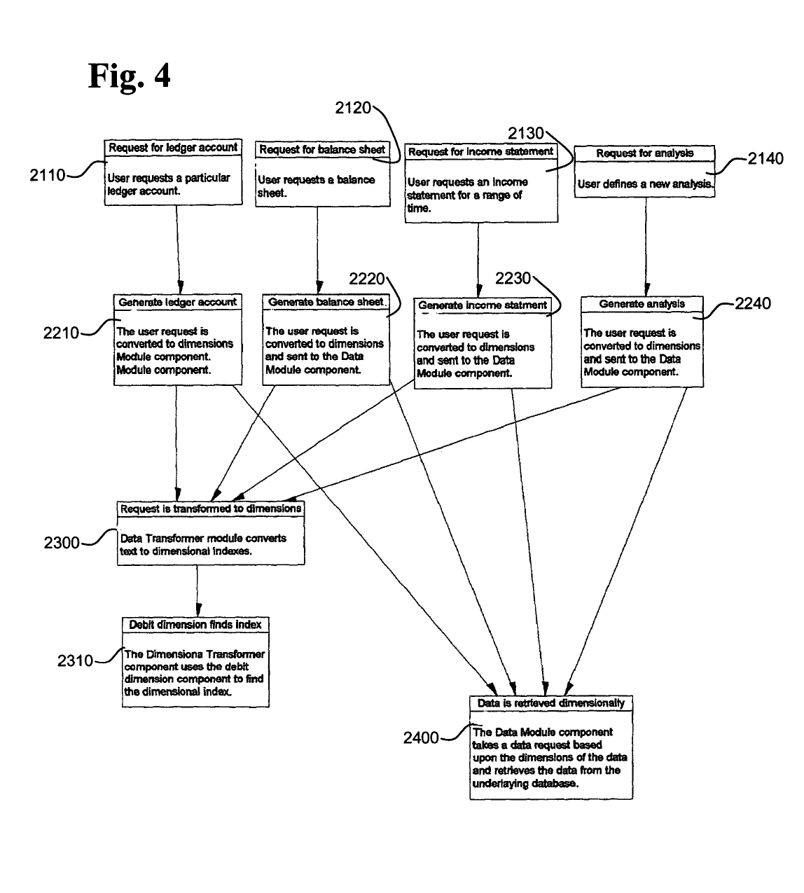

Referring to FIG. 4, there is shown generally a diagrammatic representation of the sequence of operations in requesting output data from the multi-dimensional business information accounting software engine and operations performed by the software engine. At the top of the Figure a set of boxes numbered 2110, 2120, 2130, and 2140 represent the input of a user request for analytical data. The user goes through a graphical user interface to build a request and then sends the request to an appropriate module within the multi-dimensional business information accounting software engine as shown in boxes numbered 2210, 2220, 2230, and 2240. In box 2210 the request goes to component 510 of FIG. 2. In box 2220 the request goes to component 520 of 2. In box 2230 the request goes to component 530 of FIG. 2. In box 2240 the request of influence of business factors goes to component 580 or component 590 of FIG. 2. All of the requests are made in terms of user's text and are meaningless in terms of the underlying data structure, which needs to be addressed in terms of dimension indexes rather than text. The requests are all sent to the Dimensional Transformer component (100 in FIG. 2). In the Dimensional Transformer component the textual requests are transformed by use of the Dimension software components (310, 320, 330, and 390 in FIG. 2) into dimensional indexes. This is shown in steps 2300 and 2310 of FIG. 4. The Dimensional Transformer returns the request, in dimensional form, back to the requesting component which then sends the request to the Data Module component (500 in FIG. 2). This is shown in step 2400 of FIG. 4. The Data Module component accesses the underlying database and returns the results back to the requesting component where they are eventually returned to the requesting user.

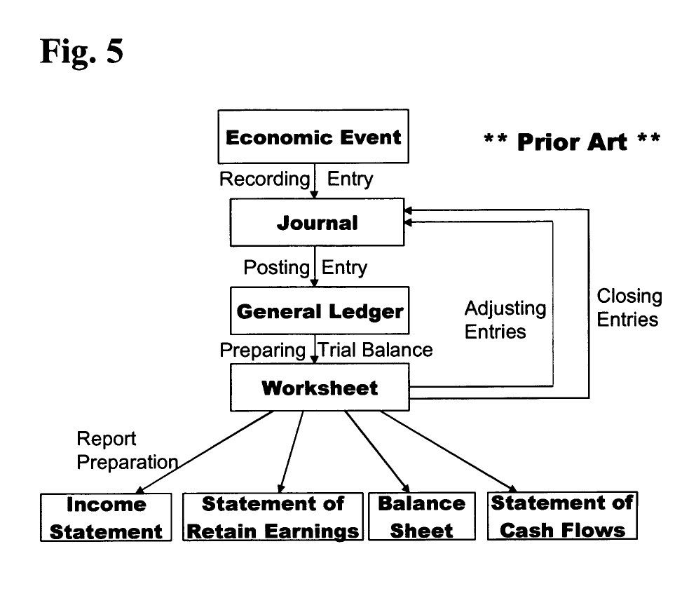

FIG. 5 is a flow chart that represents the prior art workflow how the traditional accounting process is performed. The economic event is first recorded in a journal, posted in a general ledger and work sheets including income statement, earnings statement, balance sheet and statement of cash flow are prepared. Errors in posting are corrected by adjusting entries and the books are closed after a time period.

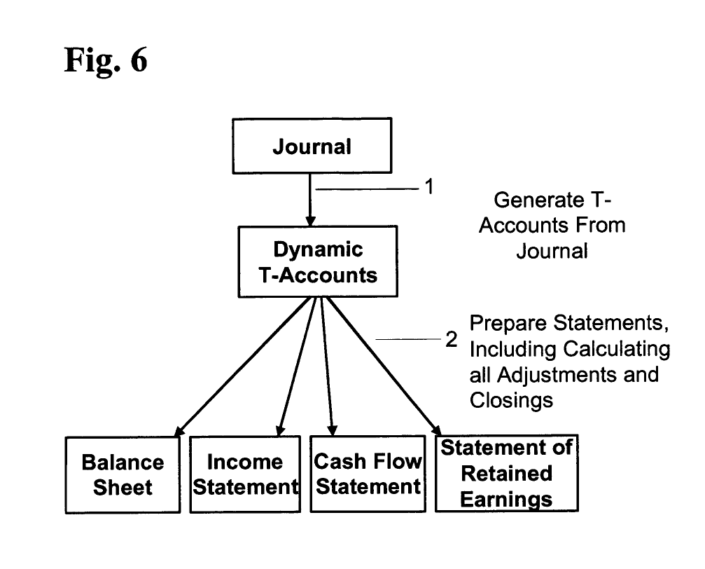

FIG. 6 is a flow chart that contrasts with the prior art of FIG. 5, showing how the accounting process would be performed with the multi-dimensional business information accounting software engine. The journal entries are dynamically used to construct the dynamic t-accounts and calculations are performed to provide balance sheet, income statement, cash flow statement and statement of earnings at the request of the user. The work flow is simpler and is free from dependence upon a fiscal time period.

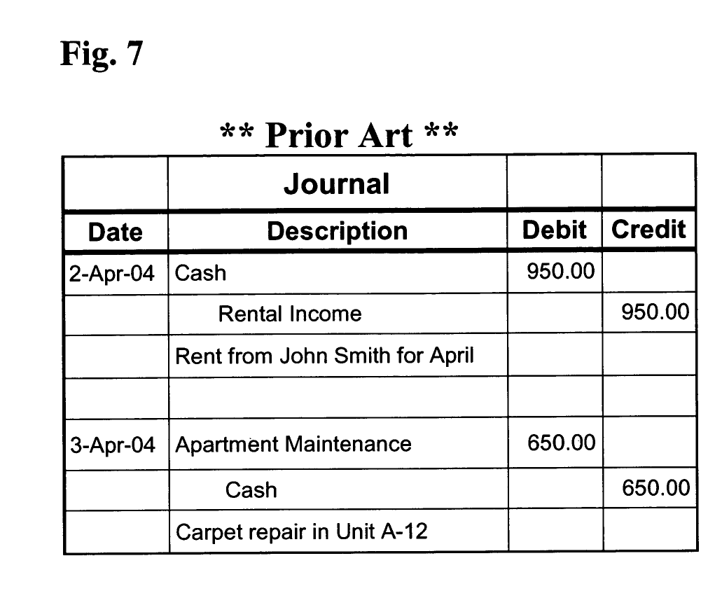

FIG. 7 is prior art, displaying how a traditional accounting journal appears in a small company that rents residential apartments. The journal entry includes date, debit and credit information, names of accounts which are credited and debited to and a textual description of the transaction, which can only be read by a user, not a machine usable quantity. These are the only information recorded in the journal for the remaining lifetime of the business.

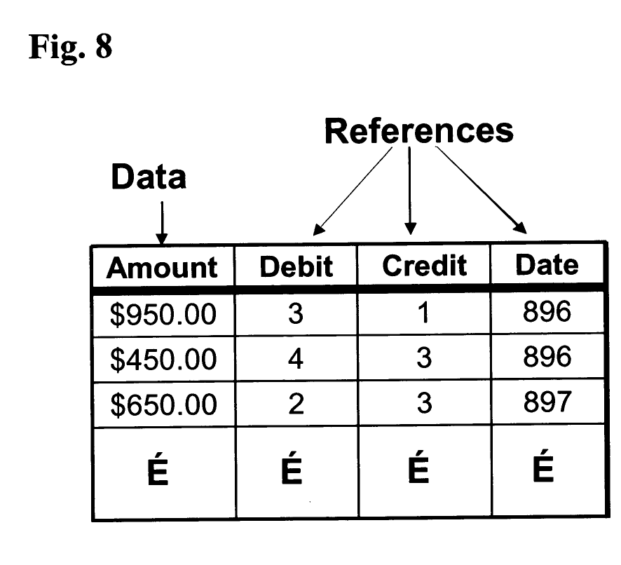

FIG. 8 is a journal using the multi-dimensional business information accounting software engine, contrasting the change from prior art of FIG. 7. The entries include an amount, a debit reference, a credit reference and a date reference. These references refer to a table which caries the appropriate information. All data can therefore be manipulated by the computer unlike textual entries in FIG. 7.

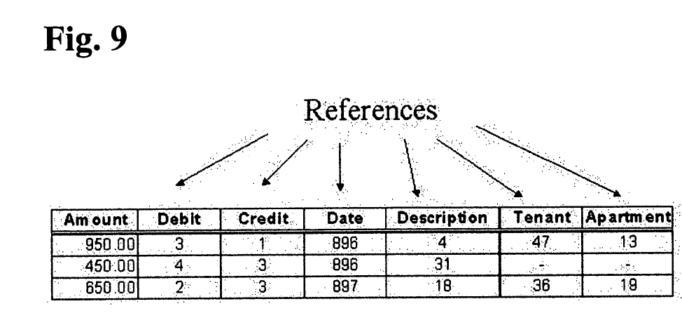

FIG. 9 is a journal using the multi-dimensional business information accounting software engine which is similar to FIG. 8, except that it has additional references (Description, Tenant, and Apartment) besides those that are specific for performing the traditional accounting functions, forming a six dimensional data structure. The references are numerically coded with a small integer to point to a particular indexed item maintained in the computer as a table. These entries are machine readable and processable in contrast with conventional textual descriptions.

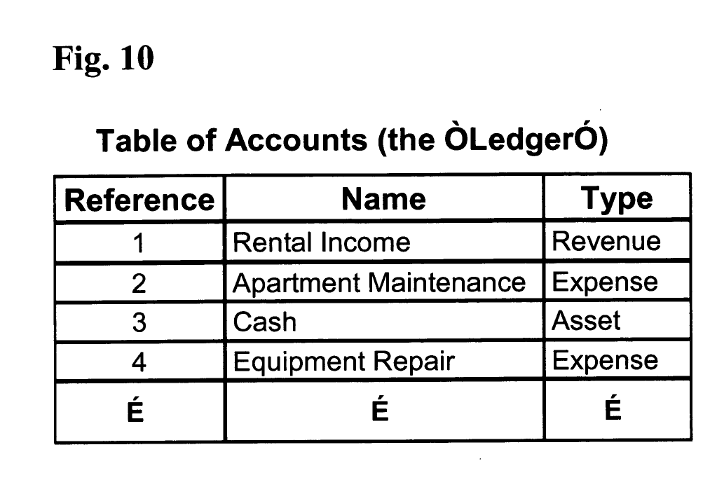

FIG. 10 is a look at the data structure that contains the ledger accounts as presented in conventional accounting systems as well as virtually presented by the multi-dimensional business information accounting software engine. Note that the accounts are simply descriptions that are referenced by the journal in FIG. 9. They do not, themselves, contain transactional information, as is the case in the traditional accounting model and in all prior art in this area.

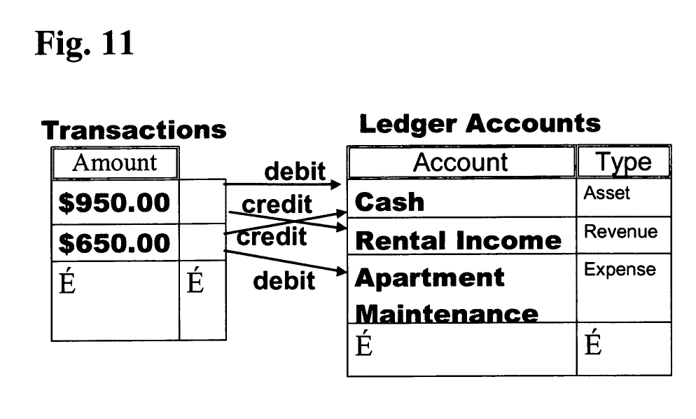

FIG. 11 demonstrates how dimensional references go from the rows of the journal (labeled “transactions”) to a data structure holding the ledger accounts. The individual transactions are listed in a table of transactions that contain the essential detail of the transaction, its financial amount, a set of references and two transactions are shown with their t-accounts in the ledger. In this multi-dimensional business information accounting software engine, these dimensional references obviate the need for a General Ledger as a repository of transactional information and create the general ledger t-accounts when requested for any requested time period.

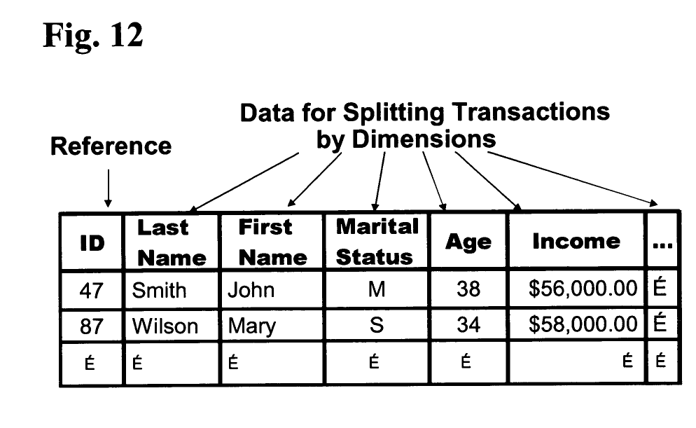

FIG. 12 is a look at a data structure that contains a non-accounting dimension. Like FIG. 10, it does not contain transactional data in itself, but rather, contains descriptive information that describes the dimensional references that are referenced in the journal shown in FIG. 9. Each row represents a specific tenant with a unique reference number with references to age, marital status, and income. Each of which may be used to moderate the accounting information, since they are all referenced quantities.

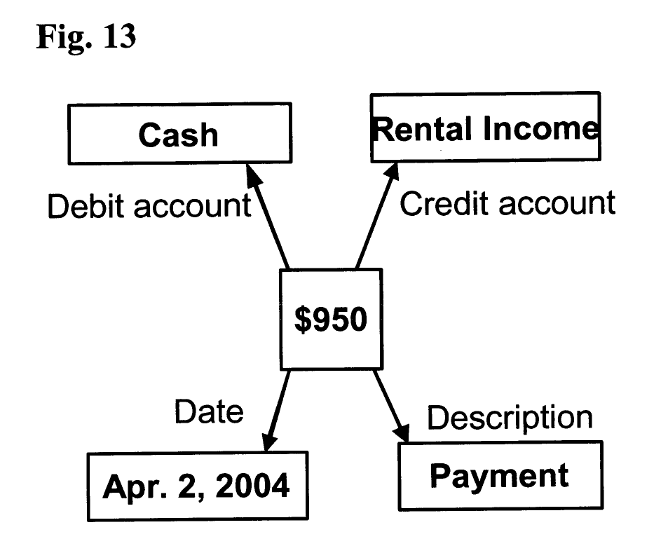

FIG. 13 is an Entity Relationship (ER) diagram showing the star schema for a simple journal accounting entry where the only dimensions are those that are implemented in the traditional accounting functions. It has the four dimensions including debit account, credit account, date and description of the transaction as shown.

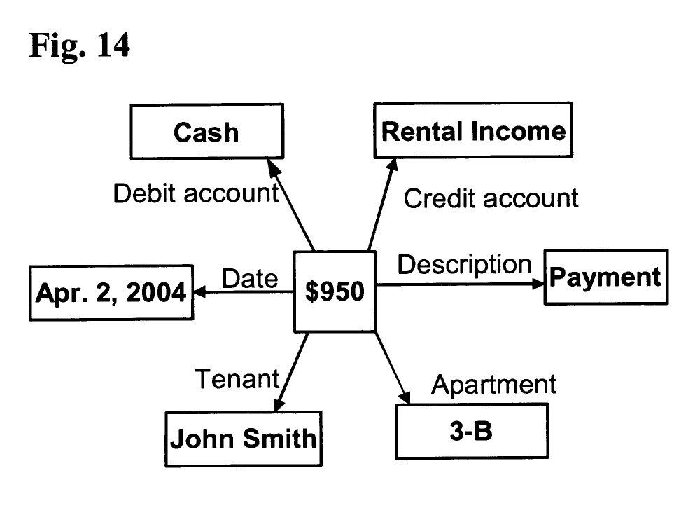

FIG. 14 is an Entity Relationship diagram showing the star schema for an extended journal accounting entry where there are dimensions (Tenant and Apartment) in addition to those that perform the traditional accounting functions. They include including debit account, credit account, date, description, tenant and apartment creating a six dimensional data structure.

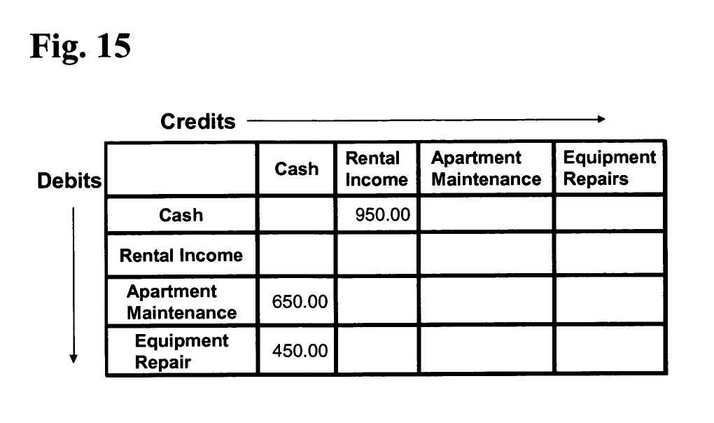

FIG. 15 is a two dimensional data structure where each dimension is a ledger account. Each cell in the data structure is located at the intersection of a row and column that represent the accounts to be debited and credited. This is an inadequate data structure for accounting because it doesn't have dimensions for data and description, but it is useful to show how, for a given account, the credit balance can be found by adding up the column that represents the account, and the debit balance for that account can be found by adding up the horizontal row that represents that account. This summing across a dimension is known, in star schema terms, as “slicing.”

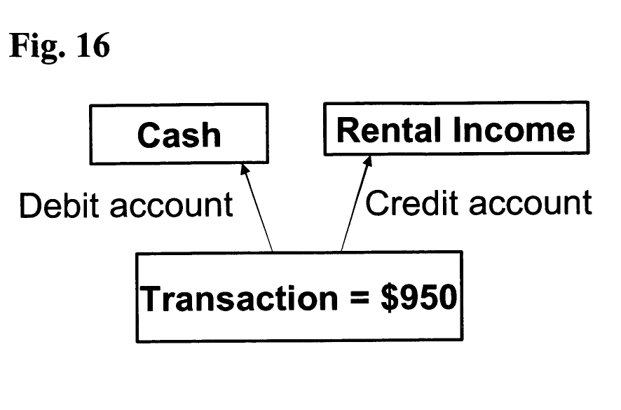

FIG. 16 is an Entity Relationship diagram showing the star schema for a simple two-dimensional accounting system (ledger accounts only). In a typical analytical database this information will be kept in the tabular form. However, the star schema shown in this figure better expresses the way the information is kept in the database.

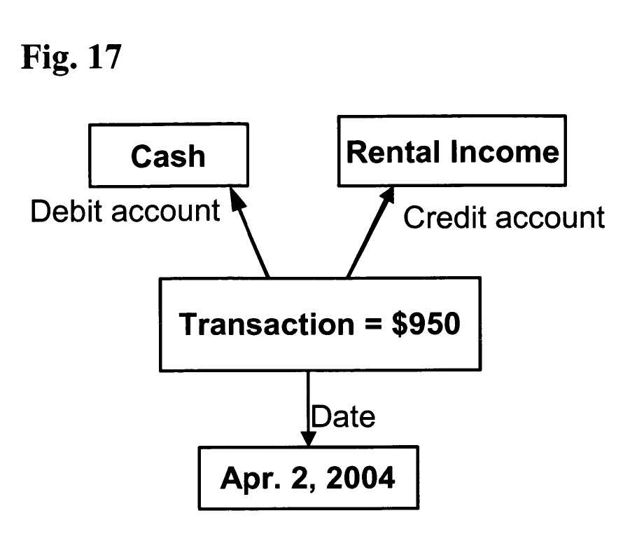

FIG. 17 is an Entity Relationship diagram showing the star schema for a simple three-dimensional accounting system of a ledger account and a date. The data in this three dimensional data structure may be visualized as a cube, as shown in the next figure.

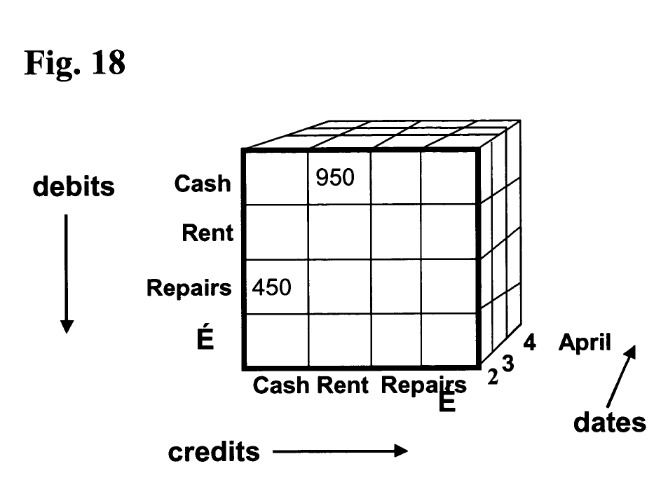

FIG. 18 is a three-dimensional “cube” containing the three dimensions (debit account, credit account, date account) shown in the Entity Relationship diagram in FIG. 17, with each dimension of the cube corresponding to an arm of star schema of FIG. 17. Later diagrams will show how this cube is “sliced” to generate traditional accounting information.

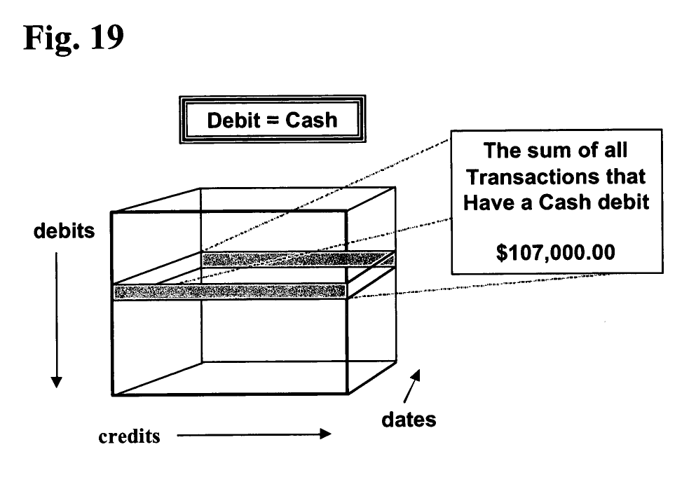

FIG. 19 is the three-dimensional cube previously shown in FIG. 18 with a “slice” made through one of its dimensions. This slice is simply the summing of all the cells in the debit dimension for the row representing the “Cash” account. This slice provides sum total of all transactions that have a cash debit for all dates and credits in the database.

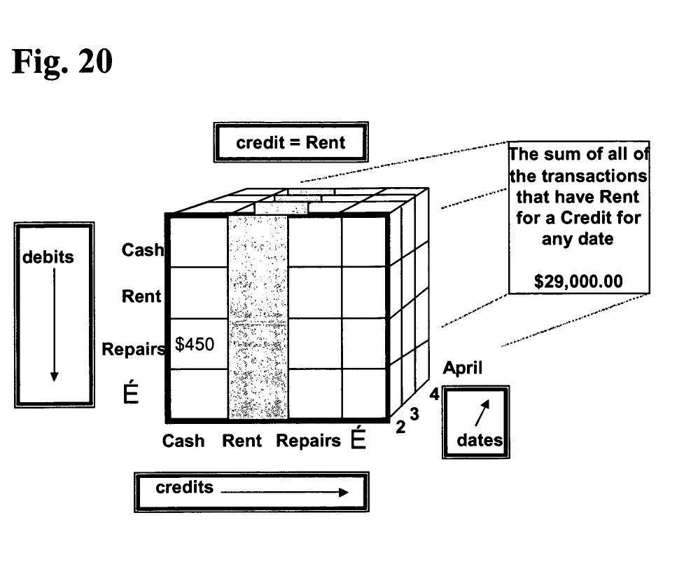

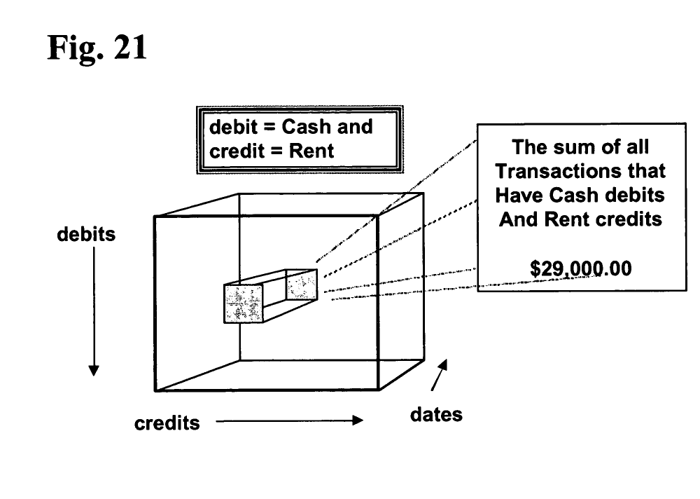

FIG. 20 is the three-dimensional cube originally shown in FIG. 18 with a “slice” made through its credit dimension. This slice is simply the summing of all the cells in the credit dimension for the column representing the “Rent” account. This may represent the credit balance in a ledger account across many dates. A debit dimension slice, as shown in FIG. 20, and a credit dimension slice, as shown in FIG. 21, for the same account gives us the total balance for that account.

FIG. 21 is the three-dimensional cube originally shown in FIG. 18 with a slice through two dimensions, a debit dimension for the Cash account and a credit dimension for the Rent account. This reflects the cash inflow from rent. A number of these slices, further limited by a range of the date dimension that represents the reporting period, generate a Cash Flow Statement.

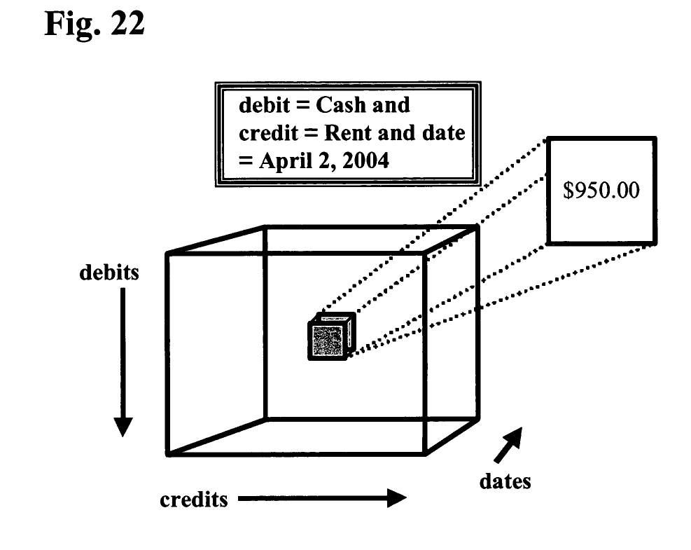

FIG. 22 is the three-dimensional cube originally shown in FIG. 18 with a slice through three dimensions, a debit dimension for the Cash account, a credit dimension for the Rent account, and a data dimension for the date Apr. 2, 2004. Again, a number of these slices would generate a Cash Flow Statement for that date. If that day was expanded to a range of dates, for example, Apr. 1, 2004 to Apr. 30, 2004, it would serve for a Cash Flow Statement for the month of April, 2004.

Although a multi-dimensional data structure is conveniently implemented using a star schema design technique in a relational database, that particular embodiment does not limit it as an invention. Any structuring of data that supports a star schema suffices as a raw material upon which this invention can be based. Rather than a relational database designed with interrelated tables, the exact implementation could be a set of text files on a hard-disk drive that contain references to each other. The exact implementation in a relational database or any other form of interrelating the data is a matter of expression and is the subject of copyright law as opposed to patent law where it is the idea, as opposed to its specific expression, that is relevant.

The key features of the multi-dimensional business information accounting software engine include, in combination, the features set forth below:
1. All accounting reports including standard accounting reports and business feature related accounting reports can be created dynamically upon the user's request;
2. Unlike a conventional accounting journal, which relates a transaction to a debit account and a credit account, a multi-dimensional data structure allows each entry of business factor data to be stored and analyzed using procedures far exceeding current accounting practices;
3. Standard accounting reports and business factors related accounting reports can be limited to any range of dates that the user is interested in;
4. Ledger accounts, cash flow statements and profit and loss statements are dynamically generated from the multi-dimensional data structure and have no physical existence of their own, avoiding duplication of data between the journal and the ledger accounts which results in the consistency problems that are typically inherent in duplicated data;
5. Simplicity provided by bookkeeping staff having only to enter the transactions into the multi-dimensional business information accounting software engine while the multi-dimensional business information accounting software engine automatically performs all the other accounting processes; and
6. The ability to add additional business factors into the data structure of the “star” schema without affecting the underlying data already collected.

Having thus described the invention in rather full detail, it will be understood that such detail need not be strictly adhered to, but that additional changes and modifications may suggest themselves to one skilled in the art, all falling within the scope of the invention as defined by the subjoined claims.

1. A multi-dimensional business information accounting software engine, comprising:
a. a data structure dimension definition means for defining star schema multi-dimensional data that includes business specific information and accounting financial data;
b. data input means for inputting said star schema multi-dimensional data into said multi-dimensional business information accounting software engine, forming journal entries;
c. user interface means for requesting said multi-dimensional business information accounting software engine to provide conventional accounting statements;
d. said multi-dimensional business information accounting software engine calculating upon user request of said conventional accounting statements for specified time periods based on said journal entries;
e. user interface means for requesting said multi-dimensional business information accounting software engine to provide one or more business specific information modified accounting statements;
f. said multi-dimensional business information accounting software engine calculating upon user request accounting statements modified by one or more of said business specific information for specified time periods based on said journal entries
whereby the user is provided with up to date conventional accounting statements for the specified time periods and the effect of business specific information on accounting statements.

2. A multi-dimensional business information accounting software engine as recited by claim 1, wherein said business specific information comprises numerical quantities and textual information.

3. A multi-dimensional business information accounting software engine as recited by claim 1, wherein said accounting financial data comprises date information, debit information, credit information and descriptions.

4. A multi-dimensional business information accounting software engine as recited by claim 1, wherein said data input means comprises manual entry of said star schema multi-dimensional data.

5. A multi-dimensional business information accounting software engine as recited by claim 1, wherein said data input means comprises bulk loader input of said star schema multi-dimensional data.

6. A multi-dimensional business information accounting software engine as recited by claim 1, wherein said conventional accounting statements for specified time periods comprises general ledger, balance sheets, cash flow statements, profit and loss statements and earned income statements.

7. A multi-dimensional business information accounting software engine as recited by claim 2, wherein said business specific information moderated accounting statements for specified time periods comprises general ledger, balance sheets, cash flow statements, profit and loss statements and earned income statements modified by a range of numerical quantities of business specific information.

8. A multi-dimensional business information accounting software engine as recited by claim 3, wherein said business specific information moderated accounting statements for specified time periods comprises general ledger, balance sheets, cash flow statements, profit and loss statements and earned income statements modified by a textual business specific information.
